(19) United States
(12) Patent Application Publication
(10) Pub. No.: US 2010/0082507 A1
(43) Pub. Date: Apr. 1, 2010

(54) Predicting Performance Of Executing A Query In Isolation In A Database

(76) Inventors: Archana Sulochana Ganapathi, Palo Alto, CA (US); Harumi Anne Kuno, Palo Alto, CA (US); Umeshwar Dayal, Saratoga, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/242,692

(22) Filed: Sep. 30, 2008

(51) Int. Cl. G06F 15/18; G06F 17/30

(52) U.S. Cl. 706/12; 707/E17.014

(57) ABSTRACT

One embodiment is a method that generates query vectors from query plans and performance vectors from data collected while executing queries in a database. The method then uses a machine learning technique (MLT) to compute distances between two query vectors and two performance vectors and to predict performance of executing a new single query in isolation in the database.

### CROSS-REFERENCE TO RELATED APPLICATIONS

This application relates to commonly assigned U.S. patent applications having attorney docket number HP 200704074-1 entitled “Reverse Mapping of Feature Space to Predict Execution in a Database” and filed on Jul. 5, 2008; attorney docket number HP 200704077-1 entitled “Characterizing Queries to Predict Execution in a Database” and filed on Jul. 5, 2008; attorney docket number HP 200704091-1 entitled “Predicting Performance of Multiple Queries Executing in a Database” and filed on Jul. 5, 2008; attorney docket number HP 200704103-1 entitled “Managing Execution of Database Queries” and filed on Jul. 5, 2008, all of which are incorporated herein by reference.

### BACKGROUND

Business Intelligence (BI) database systems process extremely complex queries upon massive amounts of data. This capability is important to modern enterprises, which rely upon the collection, integration, and analysis of an expanding sea of information.

In BI databases, it is quite difficult to predict in advance the performance characteristics (execution time, resource usage and contention, etc.) of executing a business intelligence query in isolation on a given database system configuration. Enormous amounts of data are stored in the database, and large variances exist in the amount of data processed for different queries. Furthermore, predicting the exact amount of data that will be processed for a given query is challenging. Variances in the times needed to execute individual queries can cause wait time to significantly outweigh execution time for a given query. Such variances add to the difficulty in estimating the time needed to execute a query that will run at the same time as other unknown queries.

Database designers can realize many business benefits if they can accurately predict performance of executing queries in a database. By way of example, database designers can more efficiently design a database system for running workloads of customers. Such databases can more accurately be selected with respect to size, capacity, performance, management, and cost, to name a few examples.

### BRIEF DESCRIPTION OF THE DRAWINGS

FIG. 1 is a diagram showing each query as a vector in accordance with an exemplary embodiment of the present invention.

FIG. 2 is a diagram of a system using a machine learning technique in accordance with an exemplary embodiment of the present invention.

FIG. 3 is a diagram of a system showing prediction through the machine learning technique in accordance with an exemplary embodiment of the present invention.

FIG. 4 is a graph showing predicted versus actual time for test queries in accordance with an exemplary embodiment of the present invention.

FIG. 5 is a flow chart of a training phase for a machine learning technique in accordance with an exemplary embodiment of the present invention.

FIG. 6 is a flow chart of an exemplary usage of a system predicting performance of executing a query in isolation in a database in accordance with an exemplary embodiment of the present invention.

FIG. 7 is a block diagram of an exemplary database system in accordance with an embodiment of the present invention.

FIG. 8 is a block diagram of an exemplary computer system in accordance with an embodiment of the present invention.

### DETAILED DESCRIPTION

Exemplary embodiments in accordance with the present invention are directed to systems and methods for predicting the performance characteristics of executing a query in isolation in a database.

Exemplary embodiments include systems and methods that estimate the resource requirements (execution time, resource usage, resource contention, etc.) of executing a business intelligence (BI) workload in isolation on a given database system configuration. A machine learning algorithm creates a characterization function for encoding query features into a query characteristics feature space, a characterization function for encoding query performance characteristics into a query performance features space, and a collocation function so that given any point within the query's characteristics features space, a corresponding location is found in the query performance feature space. Exemplary embodiments create the characterization and collocation functions so as to support the maximum correlation between locations in the query characteristics and performance feature spaces.

One embodiment is illustrated with the following hypothetical example: Consider a business whose data warehouse now has one hundred times as much data as it had at installation. Queries that used to run in an hour now take days, e.g., to produce monthly global financial results. This business needs a bigger database system configuration: more CPUs, more memory, etc. The business desires to determine how much bigger its database should be expanded. Performance does not scale linearly with system size and is highly dependent on the mix of queries and data that comprise a given workload.

In this hypothetical example, if a new database system is too small, performance will not improve enough and the database will not meet the needs of the customer. On the other hand, if the new system is too powerful, then performance will improve, but the price of the new database system could be greater than a system that more efficiently met the needs of the customer. Further, the new system could be both too expensive and also inappropriate for the customer's workload. For example, purchasing one hundred times more disks and partitioning data across them will not help if poor performance is actually due to insufficient CPU resources.

Exemplary embodiments will enable a user (such as database vendor) to recommend a new system to the business customer of the hypothetical example so the database is neither too large nor too small. Exemplary embodiments predict query and workload performance and resource use so both businesses and database vendors can decide which system configuration meets the needs of the customer.

Prediction methods in accordance with exemplary embodiments support both the initial system sizing problem (for example, which system configuration to buy? what is the minimum amount to spend for satisfactory performance?) and the capacity planning problem (for example, what will happen to performance as more data is added?). These problems are of interest both to database customers and to database system vendors. Furthermore, exemplary embodiments provide good query and workload predictions so users know when their queries will finish, without requiring them to know what else is running in the system.

One embodiment applies a methodology that accurately predicts multiple performance metrics (including elapsed time and resource requirements, such as CPU time, disk I/Os, memory usage characteristics, and number of messages) simultaneously. One embodiment predicts the performance of individual queries running in isolation, based only on their query plans, which are available before runtime.

A machine learning technique (MLT) is used to derive a prediction model for each system configuration from benchmark queries and then make predictions based on the measured performance metrics of previously run queries and workloads. Rather than explicitly modeling hardware performance, one embodiment uses a machine learning technique or algorithm to find correlations between the query plan properties and query performance metrics on a training set of queries and then use these correlations to predict the performance of new queries.

Exemplary embodiments are applicable to any database system and configuration using a variety of workloads and datasets. Further, exemplary embodiments are applicable to a wide range of query sizes (execution times that span milliseconds to hours or longer). Further, many data warehouse vendors support a small set of fixed hardware configurations (e.g., fixed amount of memory per CPU or few choices for the number of CPUs). Since performance varies dramatically from one configuration to another, one embodiment trains and predicts on a separate model for each supported hardware configuration. Predicted performance is then compared for each configuration to determine the optimal system size for a given customer workload. Thus, exemplary embodiments characterize the workload and the system performance simultaneously. This characterization produces a detailed picture of both the queries that make up the workload as well as numerous system performance metrics.

One embodiment uses machine learning techniques to first derive a model based on a training set of previously executed data points (queries) and their measured performance. The technique then predicts performance for unknown (“test”) data points based on this model. Exemplary embodiments then capture the interdependencies among multiple performance metrics and predict them simultaneously using a single model. One embodiment uses a Kernel Canonical Correlation Analysis (KCCA) as the machine learning technique.

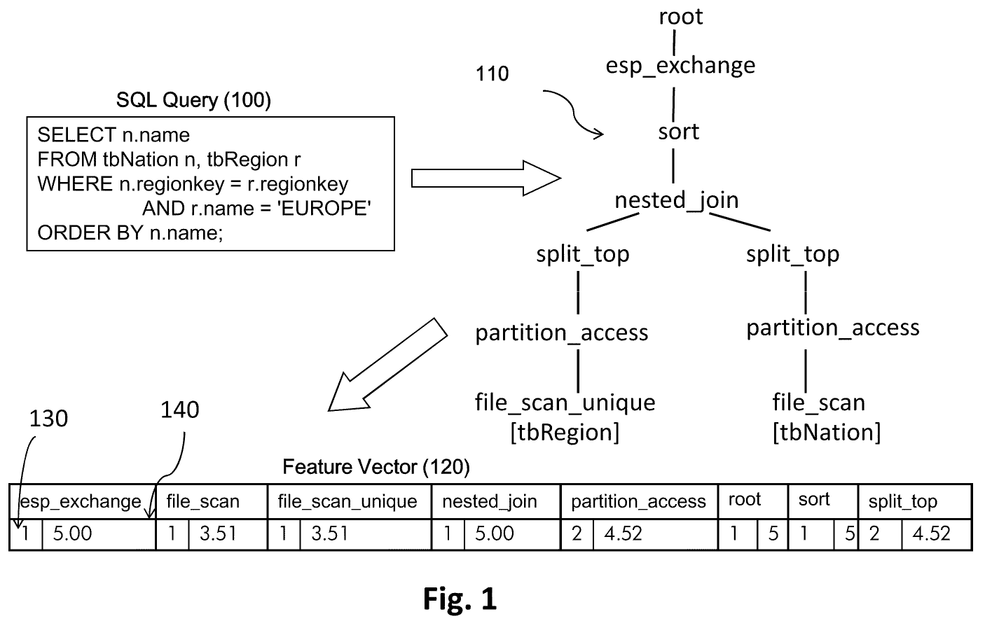

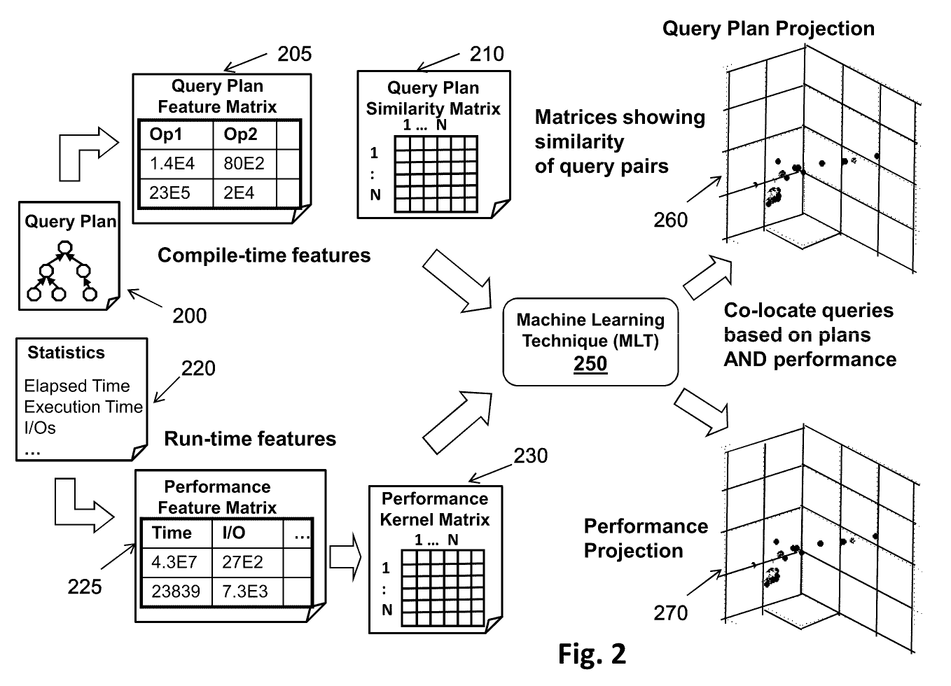

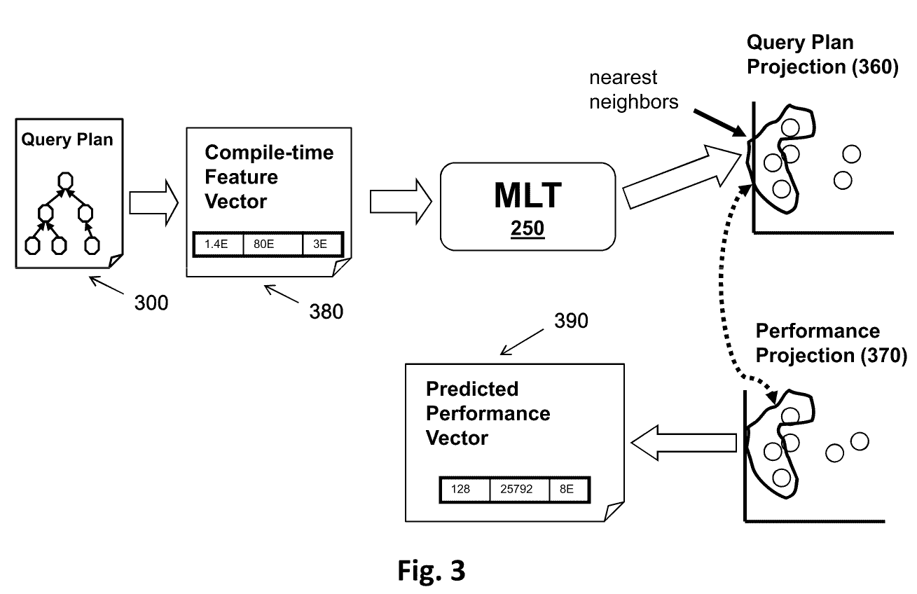

In one embodiment, the machine learning technique predicts query and workload performance. In order to map performance prediction onto the data structures and functions used by the machine learning technique, several issues are explained. First, how exemplary embodiments represent the information about each query available before running it as a vector of “query plan features” and the performance metrics available after running it as a vector of “query performance features.” This explanation is provided in the discussion of FIG. 1. Second, how exemplary embodiments define the similarity between any pair of query plan vectors and any pair of query performance vectors (i.e., define the kernel functions). This explanation is provided in the discussion of FIG. 2. Third, how exemplary embodiments use the output of the machine learning technique to predict the performance of new queries. This explanation is provided in the discussion of FIG. 3.

FIG. 1 is a diagram showing each query as a vector in accordance with an exemplary embodiment of the present invention.

Before running a query 100 (such as an SQL query), the database query optimizer produces or generates a query plan 110 that includes a tree of query operators with estimated cardinalities. This query plan 110 creates a query plan feature vector 120. While an embodiment could use just the query text, two textually similar queries could have dramatically different plans and performance due to different selection predicate constants. The query optimizer's plan, which is produced in milliseconds or seconds, is more indicative of performance and not process intensive to obtain.

The query plan feature vector 120 includes an instance count and cardinality sum for each possible operator. For example, if a sort operator appears twice in a query plan with cardinalities 3000 and 45000, the query plan vector includes a “sort instance count” field containing the value 2 and a “sort cardinality sum” field containing the value 48000. The cardinality sum is the number of rows that the query optimizer predicts will be needed to satisfy the query. FIG. 1 shows the number of instances of the operator 130 in the query (for example, shown as 1 under esp_exchange and 1 under file_scan) and shows the sum of cardinalities 140 for each instance of the operator (for example, shown as 5.00 for esp_exchange and 3.51 for file_scan).

FIG. 1 shows the query plan 110 and resulting feature vector 120 for a simple query (although it omits operators whose count is 0 for simplicity). The intuition behind this representation is that each operator “bottlenecks” on some particular system resource (e.g. CPU or memory) and the cardinality information encapsulates roughly how much of the resource is expected to be consumed. Other features can also be included, such as an indication of tree depth and bushiness.

In one embodiment, a query performance vector is created from the performance metrics that the database system collects when running a test query in isolation. By way of illustration, such metrics include elapsed time, memory usage characteristics, disk I/Os, message count, message bytes, records accessed (the input cardinality of the file scan operator) and records used (the output cardinality of the file scan operator). In this example, the performance vector would have six elements.

Second, as discussed, exemplary embodiments also define the similarity between any pair of query plan vectors and any pair of query performance vectors (i.e., define the kernel functions). As shown in FIG. 2, a query plan 200 is used to develop or compute a query plan feature matrix 205 and a query plan similarity matrix 210. Further, statistics 220 (such as elapsed time, execution time, I/Os, etc.) are used to develop or compute a performance feature matrix 225 and a performance kernel matrix 230. The query plan similarity matrix 210 and the performance kernel matrix 230 are input into the machine learning algorithm or technique 250 which generates a query plan projection 260 and a performance projection 270.

In one embodiment, the machine learning technique 250 uses a kernel function to compute “distance metrics” between any two query plan vectors and any two query performance vectors. By way of example, one embodiment uses a Gaussian kernel that assumes only the raw feature values follow a simple Gaussian distribution. The variance in a Gaussian distribution is the standard deviation squared for these values. For example, given N queries, form an N×N matrix L where L(i,j) is the computed similarity between query plan vectors i and j. The query plan kernel matrix is lower-triangular and similarity is normalized to 1, i.e. L(i,j)=1 if i=j. The N×N matrix P of similarity is computed between each pair of query performance vectors (for example, 6-dimensional vectors for the example provided above).

The machine learning technique 250 clusters queries with similar query plan feature vectors and similar performance features vectors. Given matrices L and P of dimension N×N, the machine learning technique finds subspaces of a dimension D<N (D is chosen by the machine learning technique) onto which each can be projected, such that the two sets of projections are maximally correlated. This corresponds to solving a generalized eigenvector problem as shown in FIG. 2. More concretely, the machine learning technique produces a matrix A consisting of the basis vectors of a subspace onto which L is projected (giving L×A), and a matrix B consisting of basis vectors of a subspace onto which P is projected, such that L×A and P×B are maximally correlated.

Third, as discussed, exemplary embodiments also use the output of the machine learning technique to predict the performance of new queries. FIG. 3 is a diagram of a system showing prediction through the machine learning technique in accordance with an exemplary embodiment of the present invention. As shown, the query plan 300 and compile time feature vector 380 are input into the machine learning technique 250 which generates the query plan projection 360 and the performance projection 370. The machine learning technique 350 projects a new query plan vector and then uses nearest neighbors to find the corresponding location on the query performance projection 370 to derive the new query's predicted performance vector 390 from those nearest neighbors.

In one embodiment, predicting the performance of a new query involves two steps. First, exemplary embodiments create its query plan feature vector and identify its coordinates on MLT's query plan projection L×A. Then the k nearest neighbors in the projection (using any one of a number of methods to calculate distance, such as Euclidean distance or cosine distance) are found from among the known queries. By way of illustration, embodiment use k=3, 4, or 5. When k>5, predictions could become skewed by neighbors that are actually too far away. Then, the positions of the k nearest neighbors are compared in the performance metric feature space to those of the points located around them. If there is a point P in the performance metric feature space that is closer to each of the k nearest neighbors than they are to each other, then this point P is looked up in the map between performance metric input vectors and the performance metric feature space, and the corresponding performance metric input vector is used to produce estimated performance metrics for the new query.

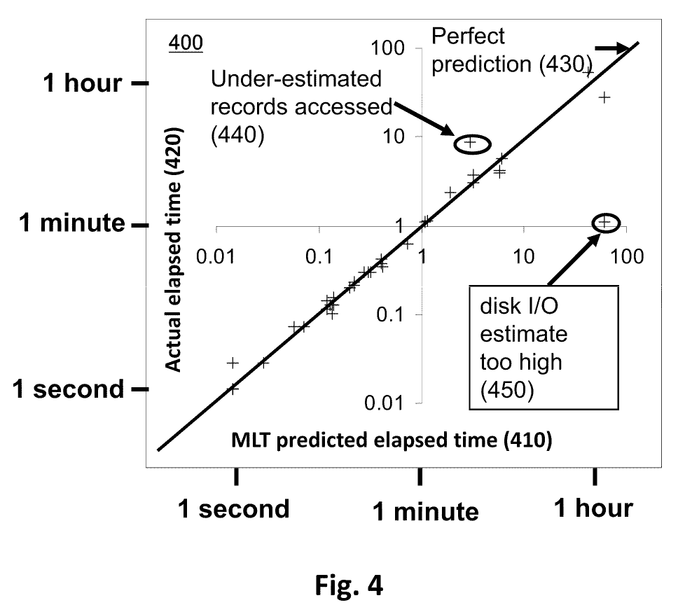

FIG. 4 is a graph 400 showing predicted versus actual time for test queries in accordance with an exemplary embodiment of the present invention. A log-log scale is used to accommodate a wide range of query execution times from milliseconds to hours for fifty four test queries.

The X-axis is labeled as the MLT predicted elapsed time 410, and the Y-axis is labeled actual elapsed time 420. The perfect prediction line 430 shows the predictions with no errors. As shown, the predicted results closely follow the perfect prediction line 430. The closeness of nearly all of the points on the diagonal line (perfect prediction line 430) indicates the accuracy of the predictions. One errant result 440 is the result of an under-estimated of a number of records accessed, and another errant result 450 is a disk I/O estimate that is too high.

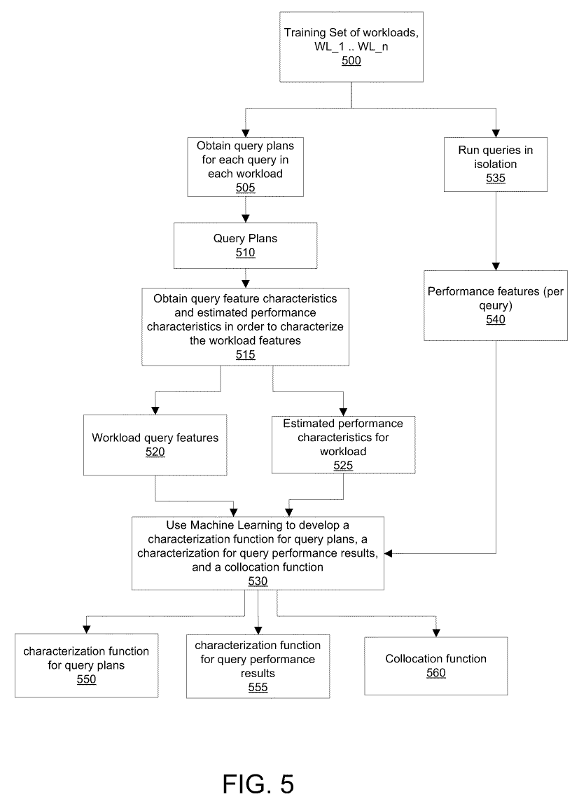

FIG. 5 is a flow chart of an exemplary usage of a system predicting performance of executing a single query in isolation in a database in accordance with an exemplary embodiment of the present invention.

According to block 500 one or more training sets of representative workloads are obtained and/or identified (for example, a training set of workloads: WL_1, WL_2, . . . WL_n). The data necessary to execute the queries of the workloads is loaded onto the database system configuration.

According to block 505, the query plans (shown in block 510) for each query in each workload is obtained. For each workload in the training set, one embodiment collects the workload's queries' execution plans as well as the performance results of running the queries in isolation on the database system configuration.

According to block 535, the workloads are run or executed for queries in isolation in the database system. The output from block 535 includes the performance features per query (shown in block 540), and this data is input in to the machine learning algorithm (shown in block 530).

One embodiment collects performance results for running each query in isolation in the database system. Exemplary embodiments then encode the information in each query's execution plan as a “compile-time feature vector.” This feature vector describes the query and contains, for example, counts and cardinalities for each operator of the query's execution plan. A similar performance metrics feature vector is generated for the performance metrics for running each training query in isolation in the database system.

Another embodiment collects performance results for running each workload in its entirety in the database system. Exemplary embodiments then encode the information in each workload's queries' execution plans as a “compile-time feature vector.” This feature vector describes the workload and contains, for example, counts and cardinality estimates for each operator. An alternative “compile-time feature vector” includes not only the counts and cardinality estimates for the various operators of the workloads' queries, but also the predicted performance metrics features vectors associated with each query. A similar performance metrics feature vector is generated for the performance metrics for each workload. One embodiment derives a workload's feature vector based on the workload's queries' feature vectors and queries' predicted performance metric vectors.

Thus, according to block 515, embodiments obtain query feature characteristics and estimated performance characteristics in order to characterize query features. The workload query features (shown in block 520) and the estimated performance characteristics for the workload (shown in block 525) are input into the machine learning algorithm (shown in block 530).

According to block 530, an exemplary embodiment uses machine learning (ML) or a machine learning algorithm (MLA) to develop a characterization function for query plans (shown as output in block 550) and a characterization function for query performance results (shown as output in block 555) in such a way that the similarity between any two queries' plans correlates to the similarity between those same two queries' performance characteristics. By way of example, this step (in a simple embodiment) produces two maps. One map locates queries according to their plan characteristics in such a way that two queries that are co-located on one map will also be co-located on the other map.

One embodiment creates a collocation function (shown as output in block 560) between query feature characteristics (i.e., derived from the query's execution plan) and query performance characteristics (i.e., derived from actual data obtained from running the query) so that given a location on one map a corresponding location on the other map can be determined.

Given a new query, one embodiment uses the query plan characterization function to characterize the new query's plan and locate it on the query plan characterization map. The collocation function is used to identify the corresponding location on the performance characteristics map.

As shown in FIG. 5, the machine learning algorithm outputs the characterization function for query plans 550 and the characterization function for query performance results 555.

To develop the characterization functions, exemplary embodiments use a machine learning algorithm (for example, a Kernel Canonical Correlation Analysis: KCCA) with the following procedure.

First, the procedure takes as input a set of vectors representing the query plans and a set of vectors representing the performance metrics. Next, it imposes a notion of “similarity” between two query plans using kernel functions. The result of this step produces matrices that encode the similarity of each query plan in the training set with every other query plan in the training set (and similarly for the performance metrics). Next, the procedure uses canonical correlation analysis to identify the dimensions of maximal correlation between the query plans and the performance metrics. The training set data is projected onto these dimensions to generate the maps as previously described. Next, given a new query, the procedure determines its position on the query plan map, identifies its nearest neighbors on the map (using one of any number of measures of distance, for example Euclidean distance or cosine distance), and retrieves the corresponding neighbors on the performance characteristics map to calculate the new query's performance predictions. For example, an exemplary embodiment might use a simple collocation function that would do something like average the performance metric measurements of the nearest neighbors to produce an estimate of performance metrics for the new point.

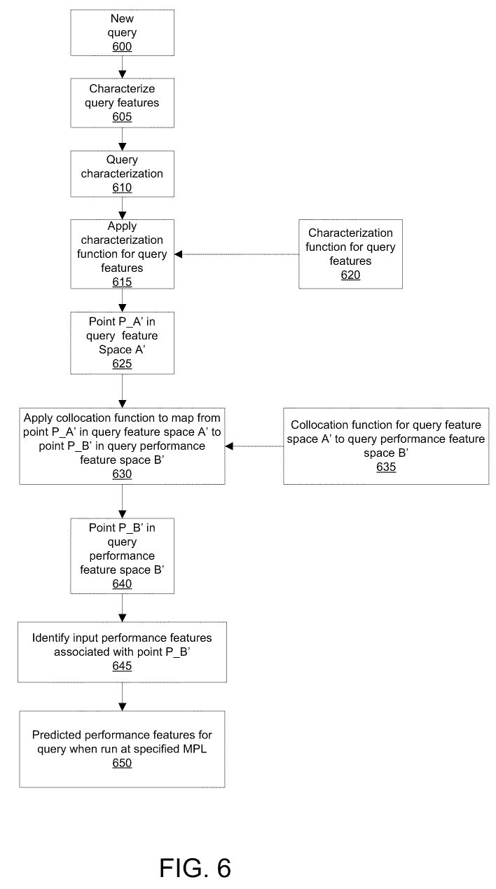

FIG. 6 is a flow chart of an exemplary usage of a system predicting performance of executing a query in isolation in a database in accordance with an exemplary embodiment of the present invention.

A new query (shown in block 600) is input into the system. Then according to block 605, the method characterizes the query features for the new query. The query features (shown in block 610) and the characterization function for the query features (shown in block 620) are used to apply a characterization function for the query features per block 615. The output is shown in block 625 as point P_A′ in query feature space A′. Then, the collocation function for query feature space A′ to query performance feature space B′ is input (shown in block 635). Next, according to block 630, the collocation function maps from point P_A′ in query feature space A′ to point P_B′ in query performance feature space B′. The output from block 630 is shown as point P_B′ in workload performance feature space B′ (shown in block 640). Next, according to block 645, the method identifies input performance features associated with point P_B′. The output is provided as predicted performance features for query when run at specified MPL (shown in block 650).

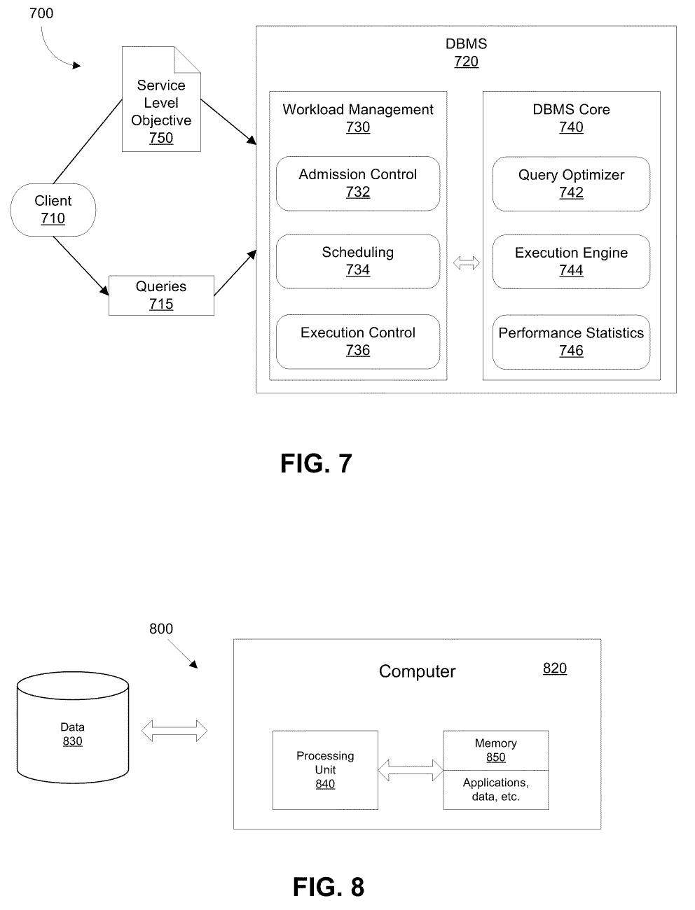

FIG. 7 is a database system 700 for managing the execution of database queries in accordance with an exemplary embodiment of the present invention. The system generally includes a computer or client 710 that sends queries 715 to a Database Management System (DBMS) 720 which includes a workload management component 730 and a DBMS core 740. The workload management component includes plural components or modules as admission control 732, scheduling 734, and execution control 736. The DBMS core 740 includes plural components or modules as a query optimizer 742, an execution engine 744, and performance statistics 746. Further, Service Level Objectives (SLOs) 750 are coupled between the client 710 and the DBMS 720.

The workload management architecture 730 provides fundamental workload management functionality for admission control, scheduling, and execution control. The DBMS core 740 provides core database functionality and supply information to workload management components but does not implement workload management policies. Each job consists of an ordered set of typed queries 715 submitted by a computer or client 710, and is associated with one or more Service Level Objectives (SLOs).

Embodiments in accordance with the present invention are utilized in or include a variety of systems, methods, and apparatus. FIG. 8 illustrates an exemplary embodiment as a computer system 800 for being or utilizing one or more of the computers, methods, flow diagrams and/or aspects of exemplary embodiments in accordance with the present invention.

The system 800 includes a computer 820 (such as a host or client computer) and a repository, warehouse, or database 830. The computer 820 comprises a processing unit 840 (such as one or more processors or central processing units, CPUs) for controlling the overall operation of memory 850 (such as random access memory (RAM) for temporary data storage and read only memory (ROM) for permanent data storage). The memory 850, for example, stores applications, data, control programs, algorithms (including diagrams and methods discussed herein), and other data associated with the computer system 820. The processing unit 840 communicates with memory 850 and data base 830 and many other components via buses, networks, etc.

Embodiments in accordance with the present invention are not limited to any particular type or number of databases and/or computer systems. The computer system, for example, includes various portable and non-portable computers and/or electronic devices. Exemplary computer systems include, but are not limited to, computers (portable and non-portable), servers, main frame computers, distributed computing devices, laptops, and other electronic devices and systems whether such devices and systems are portable or non-portable.

Execution time can vary significantly depending on the resource needs of the query and the resource needs of the other queries being executed in isolation or at the same time. By explicitly predicting and modeling the resource needs of the queries that make up the workload, exemplary embodiments provide a more complete characterization of how the individual queries in a given workload interact and thus provide more accurate predictions of a query's performance characteristics. Exemplary embodiments also includes methods to build a model of how to characterize the queries in the training set so as to create clusters of queries that will be likely to exhibit similar performance characteristics.

With exemplary embodiments, users (such as DBAs and database designers) can predict the time needed to execute one or more queries (i.e., a workload). Exemplary embodiments use machine learning to discover simultaneously (1) a characterization function for characterizing the similarity between queries as well as (2) a characterization function for characterizing similar performance of queries, and (3) a mapping function between the resulting query characteristics and the resulting performance characteristics. Exemplary embodiments provide methods and systems to predict in advance the performance characteristics (for example, execution time, resource usage, resource contention, etc.) of executing queries in isolation in a large scale BI database.

Exemplary embodiments are applicable for addressing various business needs, and some examples are provided as follows. As one example, embodiments are used to respond to a customer challenge workload: Selecting a database system configuration for running a “challenge” workload given by a customer that falls within the customer's price range yet is capable of executing the workload with at least acceptable performance. As another example, embodiments are used for sizing a database: Selecting a database system configuration to sell to a customer. The system executes the customer's business workload with at least acceptable performance, yet designs a system to be priced within the customer's budget. As yet another example, embodiments consider capacity Planning: Given a current customer who has a business workload that they are running on a given database system configuration, embodiments predict what would happen if the characteristics of the database system configuration were changed (e.g., scaled up or scaled down) or if the customer's workload were to change (e.g., if the customer were to scale up, scale down, or change the nature/distribution of their workload), or if both the database system configuration and the customer's workload were to change. As another example, embodiments are used for workload management: Given a workload and a database system configuration, select admission control, scheduling, and execution management policies that enable the workload to be executed on the database system configuration with good performance characteristics. As yet another example, embodiments are used for multi-Query optimization: Given a workload and a database system configuration, embodiments characterize how queries will interact when executing simultaneously and improve the performance of executing the workload on the database system configuration. As yet another example, embodiments provide progress indication: Given a currently executing query, embodiments determine its degree of completion and/or rate of progress and can provide this information to a user.

### DEFINITIONS

As used herein and in the claims, the following words have the following definitions:

The terms “automated” or “automatically” (and like variations thereof) mean controlled operation of an apparatus, system, and/or process using computers and/or mechanical/electrical devices without the necessity of human intervention, observation, effort and/or decision.

A “database” is a structured collection of records or data that are stored in a computer system so that a computer program or person using a query language can consult it to retrieve records and/or answer queries. Records retrieved in response to queries provide information used to make decisions. Further, the actual collection of records is the database, whereas the DBMS is the software that manages the database.

A “database administrator” or “DBA” is a person who defines or manages a database or controls access to the database.

A “database management system” or “DBMS” is computer software designed to manage databases.

The term “execution time” means the amount of time the processor or CPU is actually executing instructions. During the execution of most programs, the CPU sits idle much of the time while the computer performs other tasks, such as fetching data from the keyboard or disk, or sending data to an output device. The execution time is, therefore, generally less than the wall-clock time (i.e., the actual time as measured by a clock that the query has been running) and includes the time a query is executing in the database and not the time waiting in a queue.

Given an input data consisting of some number of vectors, the term “feature space” means the space to which all possible input vectors could be mapped. The feature space could have the same dimension as the input space or the dimensionality could be less.

The term “machine learning” means the design and development of algorithms and/or techniques that allow computers to use inductive learning methods to extract rules and/or patterns out of large data sets.

The term “query plan” or “execution plan” means a set of steps used to access information in a database, such as an SQL relational database management system.

The term “Service Level Objective” or “SLO” is a key element of a Service Level Agreement (SLA) between a Service Provider and a customer. SLOs are agreed as a means of measuring the performance of the Service Provider and are outlined as a way of avoiding disputes between the two parties based on a misunderstanding. The SLA is the contract or agreement that specifies what service is to be provided, how it is supported, times, locations, costs, performance, and responsibilities of the parties involved. The SLOs are specified measurable characteristics of the SLA such as availability, throughput, frequency, response time, or quality. Further, the SLOs can include one or more quality-of-service (QoS) measurements that are combined to produce the SLO achievement value.

A “workload” is a set of queries used for the data warehouse.

In one exemplary embodiment, one or more blocks or steps discussed herein are automated. In other words, apparatus, systems, and methods occur automatically.

The methods in accordance with exemplary embodiments of the present invention are provided as examples and should not be construed to limit other embodiments within the scope of the invention. For instance, blocks in flow diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method, comprising:
generating query vectors from query plans that include query operators;
generating performance vectors that correspond to performance data collected while executing multiple queries in a database;
using a machine learning technique (MLT) to cluster the multiple queries with similar query vectors and similar performance vectors; and
using the MLT to predict performance of executing a single query in the database.

2) The method of claim 1 further comprising:
using the MLT to create a first characterization function for encoding query characteristics into a query characterization feature space;
using the MLT to create a second characterization function for encoding performance characteristics into a performance feature space;
given a point in the query characterization feature space, finding a corresponding location in the performance feature space, wherein projections into the query characterization feature space and the performance feature space are maximally correlated.

3) The method of claim 1, wherein the query vectors include a number of instances of each operator in the query plans and include a sum of estimated cardinalities of each instance of the query operators in the query plans.

4) The method of claim 1, wherein the performance data include elapsed time, disk Input/Outputs (I/Os), memory used, and records accessed.

5) The method of claim 1 further comprising, given a point in a query characterization feature space, finding nearest neighbors of the point and using the nearest neighbors to find a corresponding location in a performance feature space.

6) A tangible computer readable storage medium having instructions for causing a computer to execute a method, comprising:
generating query vectors from query plans;
generating performance vectors from data collected while executing multiple queries in a database;
using a machine learning technique (MLT) to cluster the multiple queries with similar query vectors and similar performance vectors; and
using the MLT to predict performance of executing a new single query in the database.

7) The tangible computer readable storage medium of claim 6 further comprising, providing a compile-time feature vector for the new query input to the MLT and using the MLT to calculate nearest neighbors in both a query plan projection and a performance projection to predict performance for the new query from the nearest neighbors.

8) The tangible computer readable storage medium of claim 6 further comprising, computing at the MLT a query plan projection for the new query, and computing k nearest neighbors in the query plan projection, where k<5.

9) The tangible computer readable storage medium of claim 6 further comprising:
generating a query characteristics feature space from the query plans;
generating a query performance feature space from the performance vectors;
finding a location in the query performance feature space given a location in the query characteristics feature space.

10) The tangible computer readable storage medium of claim 6 further comprising, creating a characterization of performance features from running the multiple queries in isolation in the database.

11) A database system, comprising:
a database;
a memory for storing an algorithm; and
a processor for executing the algorithm to:
obtain query plans for training sets of queries;
execute the queries in the database to obtain performance data;
input into a machine learning technique (MLT) the performance data, estimated performance characteristics for the queries executed, and the query plans that include operator counts and cardinalities for operators in the query plans; and
use the MLT to determine similarities between the estimated performance characteristics and the performance data.

12) The computer system of claim 11, wherein the processor further executes the algorithm to use the MLT to predict performance characteristics for new queries that executed in isolation in the database.

13) The computer system of claim 11, wherein the processor further executes the algorithm to obtain performance results of running in isolation in the database each query in the training sets.

14) The computer system of claim 11, wherein the queries are executed with different hardware configurations in the database to obtain the performance data.

15) The computer system of claim 11, wherein the processor further executes the algorithm to use the MLT to cluster queries with similar query vectors and cluster queries with similar performance vectors.
